(19) United States
(12) Patent Application Publication
(10) Pub. No.: US 2025/0346048 A1
(43) Pub. Date: Nov. 13, 2025

(54) PRINTING APPARATUS AND PRINTING METHOD

(71) Applicant: FUJIFILM Corporation, Tokyo (JP)

(72) Inventor: Hayate NAKAMURA, Kanagawa (JP)

(73) Assignee: FUJIFILM Corporation, Tokyo (JP)

(21) Appl. No.: 19/277,407

(22) Filed: Jul. 23, 2025

Related U.S. Application Data
(63) Continuation of application No. PCT/JP2023/044179, filed on Dec. 11, 2023.

(30) Foreign Application Priority Data
Jan. 31, 2023 (JP) 2023-013120

(51) Int. Cl. B41J 11/00; B41J 29/377; B65H 5/06

(52) U.S. Cl. CPC B41J 11/00216; B41J 29/377; B65H 5/06; B65H 2301/5143; B65H 2301/517; B65H 2404/10; B65H 2515/805; B65H 2515/83; B65H 2557/64

(57) ABSTRACT

Provided are a printing apparatus and a printing method that can realize improvement of drying properties, suppression of substrate deformation, and suppression of jetting failure. The printing apparatus includes a print head that jets an aqueous ink onto a substrate to form an image, a substrate moisture reduction unit that reduces moisture of the substrate before the image is formed by the print head, and an absolute humidity adjustment unit that adjusts an absolute humidity in a periphery of a nozzle surface of the print head.

### CROSS-REFERENCE TO RELATED APPLICATIONS

The present application is a Continuation of PCT International Application No. PCT/JP2023/044179 filed on Dec. 11, 2023 claiming priority under 35 U.S.C § 119(a) to Japanese Patent Application No. 2023-013120 filed on Jan. 31, 2023. Each of the above applications is hereby expressly incorporated by reference, in its entirety, into the present application.

### BACKGROUND OF THE INVENTION

### 1. Field of the Invention

The present disclosure relates to a printing apparatus and a printing method, and particularly to an ink jet printing technology.

### 2. Description of the Related Art

JP2017-35870A describes a jetting device comprising a cooling unit that cools a recording medium, a humidifying unit that humidifies the recording medium in a state in which a temperature is decreased by the cooling unit, and a jetting unit that jets liquid droplets onto the recording medium humidified by the humidifying unit.

JP2000-203007A describes an ink jet recording apparatus that performs printing by jetting ink droplets from a print head and causing the ink droplets to adhere to printed matter, the ink jet recording apparatus including: a pre-processing device consisting of a halogen lamp disposed to face the printed matter immediately before the print head; and a post-processing device consisting of a halogen lamp disposed to face the printed matter behind the print head, in which a peak of a radiation intensity of the halogen lamp incorporated in the pre-processing device has a longer wavelength than a peak of a radiation intensity of the halogen lamp incorporated in the post-processing device.

### SUMMARY OF THE INVENTION

### [Problem 1: Drying Problem]

A drying device of a printing machine needs to have a capacity to sufficiently dry both an assumed maximum amount of moisture contained in a substrate and a jetted liquid for image formation. In a case where an image area of the substrate is not sufficiently dried and the image area comes into contact with a pass roller, a front surface of the image area is transferred to the pass roller, and white dot-like defects, commonly known as “white spots”, occur.

A moisture content of the substrate is significantly large compared to a jetting amount to the substrate and cannot be disregarded. Therefore, in order to achieve robust drying performance, it is necessary to estimate the moisture content of the substrate conservatively. Therefore, in the related art, a large-sized drying device is installed at a location after the ink is jetted onto the substrate, which increases the size and cost of the device.

In a double-sided printing machine, in order to achieve mass productivity, a drying device is generally designed to have the same drying capacity for front and back surfaces. However, since a moisture content of the substrate on the back surface is reduced before printing due to drying after front surface printing, in a case where a drying device after front surface printing and a drying device after back surface printing have the same performance, the capacity of the drying device after back surface printing is often surplus.

### [Problem 2: Substrate Deformation Problem]

In a printing machine, substrate deformation may occur due to image formation, which directly affects both quality of printed matter and conveyance property and thus is often a problem. In a case where the substrate is paper, a front surface of the paper may have a shape that is wavy due to image formation, which is commonly referred to as “cockling”, and this phenomenon is generally more noticeable with thin paper. This is because the ink applied to the paper permeates to a pulp layer inside the paper, and the pulp is partially wetted, resulting in shrinkage of the paper between image and non-image parts. That is, in order to suppress the cockling, it is necessary to suppress the moisture content of the printed matter to an appropriate amount across the entire surface.

Examples of a technology for suppressing cockling in the related art include tension application by roll-to-roll, and paper stretching by suction, during drying after image formation or before and after drying. These mechanical measures require an addition of a cockling suppression unit, which increases cost. In particular, in a case of a double-sided printing machine, it is necessary to provide the cockling suppression unit before and after drying of each of the front and back surfaces.

### [Problem 3: Jetting Failure Problem]

As a countermeasure against Problems 1 and 2, the substrate may be dried before image formation (see JP2000-203007A). On the other hand, as the dried substrate passes directly below a nozzle surface of a print head, a humidity of an atmosphere in a periphery of the head is lowered, and there is a problem that the nozzle surface is dried. That is, the drying of the nozzle surface may cause the ink in a nozzle to thicken, which may deteriorate jettability of the print head and cause image defects such as streaks on the printed matter.

Regarding the problem of such jetting failure, according to experiments conducted by the inventors of the present disclosure, it has been found that in a double-sided printing machine that forms an image on a back surface after forming an image on a front surface, streaks are less likely to occur in the image formed on the back surface compared to the front surface (see FIG. 3). The reason for this is that the moisture content of the substrate increases due to the image formation on the front surface, and the humidity in the periphery of the print head performing the image formation on the back surface is higher than the humidity in the periphery of the print head performing the image formation on the front surface. Therefore, it is necessary to take measures against the problem of jetting failure before forming an image on the front surface.

The terms “front surface” and “back surface” of the substrate described herein refer to the order in which image formation is performed. That is, the “front surface” is defined as a first surface on which image formation is performed first, and the “back surface” is defined as a second surface on which image formation is performed after the image formation on the first surface. These terms do not indicate front and back sides in terms of an intended use of printed matter itself.

Regarding Problems 1 to 3 described above, in the jetting device described in JP2017-35870A, the recording medium is cooled before image formation, and then the recording medium is humidified to suppress jetting failure. However, the cooling of the recording medium is intended to suppress the jetting failure, and is not a measure against white spots or cockling.

In addition, in order to deal with variations in the moisture content and the temperature of an original substrate before image formation, it is necessary to take measures before front surface image formation. However, in the configuration of the double-sided printing described in FIG. 6 of JP2017-35870A, the cooling unit for the recording medium, which is located between a first image forming device that forms an image on the front surface and a second image forming device that forms an image on the back surface, does not serve as an effective measure (paragraph 0103 of JP2017-35870A).

In the ink jet recording apparatus described in JP2000-203007A, the paper is dried before image formation for the purpose of improving drying performance of printed matter and suppressing paper deformation. On the other hand, in JP2000-203007A, measures against drying of the ink jetting surface related to Problem 3 are not taken, and there is a possibility of jetting failure. In addition, JP2000-203007A does not describe double-sided printing.

JP2017-35870A and JP2000-203007A do not provide measures for solving all of Problems 1 to 3.

The present disclosure has been made in view of such circumstances, and an object of the present disclosure is to provide a printing apparatus and a printing method capable of achieving an improvement of drying performance, suppression of substrate deformation, and suppression of jetting failure.

A printing apparatus according to a first aspect of the present disclosure comprises: a print head that jets an aqueous ink onto a substrate to form an image; a substrate moisture reduction unit that reduces moisture in the substrate before the image is formed by the print head; and an absolute humidity adjustment unit that adjusts an absolute humidity in a periphery of a nozzle surface of the print head.

According to the first aspect, by reducing the moisture in the substrate before the image is formed, drying properties after the image is formed are improved, and deformation of the substrate is suppressed. In addition, by adjusting the absolute humidity in the periphery of the nozzle surface of the print head, the occurrence of jetting failure of the print head can be suppressed. The periphery of the nozzle surface includes a space between the nozzle surface and the substrate.

A printing apparatus according to a second aspect may be configured such that in the printing apparatus according to the first aspect, the substrate moisture reduction unit includes a first drying device that heats the substrate before the image is formed, and the absolute humidity adjustment unit adjusts the absolute humidity in the periphery of the nozzle surface by changing a drying capacity of the first drying device according to an attribute of the substrate.

Examples of the attribute of the substrate include a basis weight of the substrate, a material of the substrate, a size of the substrate, or a combination thereof. The absolute humidity in the periphery of the nozzle surface can be adjusted by adjusting a moisture content of the substrate conveyed to a position facing the nozzle surface of the print head.

For example, a relationship between the attribute of the substrate, drying conditions in the first drying device, and printing quality is experimentally examined, and the drying capacity is changed to a drying capacity suitable for the attribute of the substrate based on experimental result.

A printing apparatus according to a third aspect may be configured such that in the printing apparatus according to the second aspect, the drying capacity is changed by changing at least one of a conveyance speed of the substrate in the first drying device or a temperature of the first drying device according to the attribute of the substrate.

A printing apparatus according to a fourth aspect may be configured such that in the printing apparatus according to the second or third aspect, a heat amount applied to the substrate is changed by changing a conveyance path of the substrate in the first drying device according to the attribute of the substrate.

A printing apparatus according to a fifth aspect may be configured such that in the printing apparatus according to any one of the second to fourth aspects, the attribute of the substrate includes a basis weight of the substrate.

A printing apparatus according to a sixth aspect may be configured to comprise: in the printing apparatus according to any one of the first to fifth aspects, an electrostatic elimination device that is disposed between the substrate moisture reduction unit and the print head and removes static electricity from the substrate.

A printing apparatus according to a seventh aspect may be configured such that in the printing apparatus according to any one of the first to sixth aspects, the substrate moisture reduction unit heats the substrate before the image is formed to bring the substrate into a falling-rate drying state.

A printing apparatus according to an eighth aspect may be configured such that in the printing apparatus according to any one of the first to seventh aspects, the absolute humidity adjustment unit includes a humidification source that humidifies the periphery of the nozzle surface.

A printing apparatus according to a ninth aspect may be configured such that in the printing apparatus according to the eighth aspect, the absolute humidity adjustment unit changes a humidification amount according to an attribute of the substrate.

A printing apparatus according to a tenth aspect may be configured such that in the printing apparatus according to the eighth or ninth aspect, the absolute humidity adjustment unit includes a processor that monitors the absolute humidity in the periphery of the nozzle surface and adjusts a humidification amount provided by the humidification source in a case where the absolute humidity is equal to or less than a threshold value.

A printing apparatus according to an eleventh aspect may be configured to further comprise: in the printing apparatus according to the tenth aspect, a measuring instrument for measuring the absolute humidity in the periphery of the nozzle surface, in which the processor adjusts the humidification amount based on information obtained from the measuring instrument.

The measuring instrument may be a thermo-hygrometer that measures temperature and relative humidity, or may be an absolute hygrometer that measures absolute humidity.

A printing apparatus according to a twelfth aspect may be configured such that in the printing apparatus according to the eleventh aspect, the processor calculates the absolute humidity based on measured values of a temperature and a relative humidity obtained from the measuring instrument.

A printing apparatus according to a thirteenth aspect may be configured such that in the printing apparatus according to any one of the eighth to twelfth aspects, the humidification source includes a tube connected to a humidifier, the tube has a plurality of holes formed at a specific pitch interval, and humidified air is supplied to the periphery of the nozzle surface through the tube.

A printing apparatus according to a fourteenth aspect may be the printing apparatus according to any one of the eighth to twelfth aspects, in which the humidification source is an ultrasonic humidifier.

A printing apparatus according to a fifteenth aspect may be configured such that in the printing apparatus according to any one of the eighth to twelfth aspects, the humidification source includes a duct connected to a humidifier, and humidified air is supplied to the periphery of the nozzle surface through the duct.

A printing apparatus according to a sixteenth aspect may be configured such that in the printing apparatus according to any one of the first to fifteenth aspects, the absolute humidity adjustment unit includes an exhaust unit that exhausts dry air from an inside of the printing apparatus, and an intake unit that takes in humid outside air to the inside, and adjusts the absolute humidity in the periphery of the nozzle surface by adjusting an exhaust amount using the exhaust unit.

A printing apparatus according to a seventeenth aspect may be configured such that in the printing apparatus according to the sixteenth aspect, the absolute humidity adjustment unit includes a processor that adjusts the exhaust amount according to an attribute of the substrate.

A printing apparatus according to an eighteenth aspect may be configured to further comprise: in the printing apparatus according to any one of the first to seventeenth aspects, a second drying device that dries the substrate to which the aqueous ink is applied by the print head.

A printing apparatus according to a nineteenth aspect may be configured to further comprise: in the printing apparatus according to any one of the first to eighteenth aspects, a second print head that forms, after an image is formed on a first surface of the substrate by a first print head that is the print head, an image on a second surface of the substrate, the second surface being an opposite surface of the first surface of the substrate, in which the substrate moisture reduction unit is provided only before the image is formed on the first surface, among before the image is formed on the first surface and before the image is formed on the second surface. In the case of a double-sided printing apparatus, the substrate moisture reduction unit may not be provided before the image is formed on the second surface.

A printing apparatus according to a twentieth aspect may be configured such that in the printing apparatus according to the nineteenth aspect, the absolute humidity adjustment unit is provided only for the first print head among the first print head and the second print head. In the case of the double-sided printing apparatus, the absolute humidity in the periphery of the nozzle surface of the second print head may not be adjusted.

A printing method according to a twenty-first aspect of the present disclosure is a printing method of forming an image by jetting an aqueous ink onto a substrate from a print head, the printing method comprising: reducing moisture in the substrate before the image is formed by the print head; and adjusting an absolute humidity in a periphery of a nozzle surface of the print head.

The printing method according to the twenty-first aspect may have a configuration including the same specific aspect as the printing apparatus according to any one of the second to twentieth aspects. The printing method of the present disclosure can be understood as a method for producing printed matter (printed matter manufacturing method).

According to the present disclosure, in the printing apparatus that forms an image by jetting an aqueous ink onto a substrate from a print head, an improvement of drying performance, suppression of substrate deformation, and suppression of jetting failure can be achieved. According to the present disclosure, it is possible to produce printed matter with good quality.

### BRIEF DESCRIPTION OF THE DRAWINGS

FIG. 1 is an overall configuration diagram of a printing apparatus according to an embodiment.

FIG. 2 is a configuration diagram schematically showing a configuration of a preliminary drying unit and a front surface printing and main drying unit.

FIG. 3 is a table showing data of results of an experiment obtained by examining a relationship between a basis weight of a substrate, drying conditions in the preliminary drying unit, the number of streaks occurring on printed matter, and statuses of white spots and cockling.

FIG. 4 is a graph showing a relationship between an absolute humidity in a periphery of a nozzle surface of a print head and the number of streaks.

FIG. 5 is a table showing results of an experiment obtained by examining the number of streaks and the occurrence statuses of white spots and cockling in a case where a combination of the basis weight of the substrate and preliminary drying conditions is changed.

FIG. 6 is a table showing an example of setting of the preliminary drying conditions with respect to the basis weight of the substrate.

FIG. 7 is a table showing results of an experiment obtained by examining the number of streaks and the occurrence statuses of white spots and cockling in a case where a combination of the basis weight of the substrate S and a preliminary drying path is changed.

FIG. 8 is a table showing an example of setting of the preliminary drying path with respect to the basis weight of the substrate.

FIG. 9 is an explanatory diagram showing Form Example 1 of a humidification source.

FIG. 10 is an explanatory diagram of a tube which is the humidification source shown in FIG. 9.

FIG. 11 is an explanatory diagram showing another installation example of the humidification source.

FIG. 12 is an explanatory diagram showing Form Example 2 of the humidification source.

FIG. 13A and FIG. 13B are explanatory diagrams showing an example of a humidifier.

FIG. 14 is an explanatory diagram showing Form Example 3 of the humidification source.

FIG. 15 is a configuration diagram schematically showing an example of an exhaust and intake structure applied to the printing apparatus according to the embodiment.

FIG. 16 is a functional block diagram showing Example 1 of an electrical configuration of the printing apparatus according to the embodiment.

FIG. 17 is a functional block diagram showing Example 2 of the electrical configuration of the printing apparatus according to the embodiment.

FIG. 18 is a functional block diagram showing Example 3 of the electrical configuration of the printing apparatus according to the embodiment.

FIG. 19 is a block diagram showing an example of a hardware configuration of an information processing device that functions as a control device of the printing apparatus according to the embodiment.

### DESCRIPTION OF THE PREFERRED EMBODIMENTS

Hereinafter, preferred embodiments of the present invention will be described in detail with reference to the accompanying drawings. In the following, a traveling direction of a substrate S is referred to as a conveyance direction, and a direction perpendicular to the conveyance direction and parallel to a recording surface of the substrate S is referred to as a width direction.

### Configuration Example of Printing Apparatus

### [Overall Configuration]

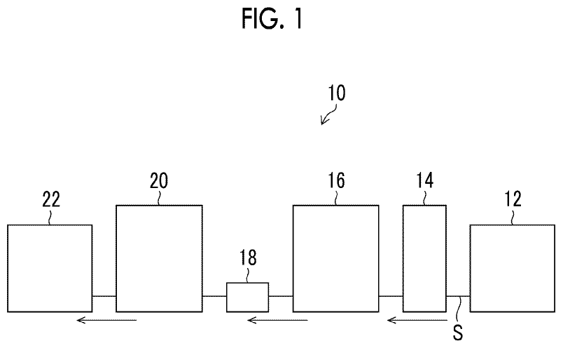

FIG. 1 is an overall configuration diagram of a printing apparatus 10 according to an embodiment. A printing apparatus 10 is a double-sided printing system that conveys a substrate S, which is a long recording medium, in a so-called roll-to-roll method and forms an image by applying an aqueous ink to the substrate S by single-pass ink jet printing. The substrate S is, for example, paper. As the paper, general printing paper primarily made of cellulose, such as so-called high-quality paper, coated paper, and art paper typically used in offset printing, or paper specifically designed for ink jet printing can be used without any particular restrictions.

The printing apparatus 10 comprises a paper feed unit 12, a preliminary drying unit 14, a front surface printing and main drying unit 16, a reversing unit 18, a back surface printing and main drying unit 20, and a paper discharge unit 22.

The paper feed unit 12 comprises a delivery roll (not shown) around which the substrate S before image formation is wound in a roll shape. The paper feed unit 12 supplies the substrate S before image formation using the delivery roll rotationally driven by a motor (not shown). The substrate S supplied from the delivery roll is conveyed to the preliminary drying unit 14.

The preliminary drying unit 14 is a drying section that performs a process (substrate moisture reduction process) of reducing moisture in the substrate S before image formation. The preliminary drying unit 14 comprises a mechanism for conveying the substrate S and a heating device for heating the substrate S. The preliminary drying unit 14 preliminarily dries the substrate S before image formation by heating the substrate S using the heating device while conveying the substrate S. As a heating method for the preliminary drying process performed on the substrate S, at least any of thermal conduction, convection, radiation, or dielectric heating can be applied. The preliminary drying unit 14 adjusts a moisture content of the substrate S entering the front surface printing and main drying unit 16. The substrate S discharged from the preliminary drying unit 14 is conveyed to the front surface printing and main drying unit 16.

The front surface printing and main drying unit 16 comprises a conveyance mechanism that conveys the substrate S, a print head that jets the aqueous ink onto the substrate S, and a drying device that dries the aqueous ink applied to the substrate S. The print head applies the aqueous ink to a front surface, which is the recording surface, of the substrate S to form an image. The drying device of the front surface printing and main drying unit 16 dries the aqueous ink applied to the substrate S while conveying the substrate S on which the image is formed. A process of drying the aqueous ink applied to the substrate S from the print head is referred to as “main drying”. The main drying may be rephrased as “main drying”.

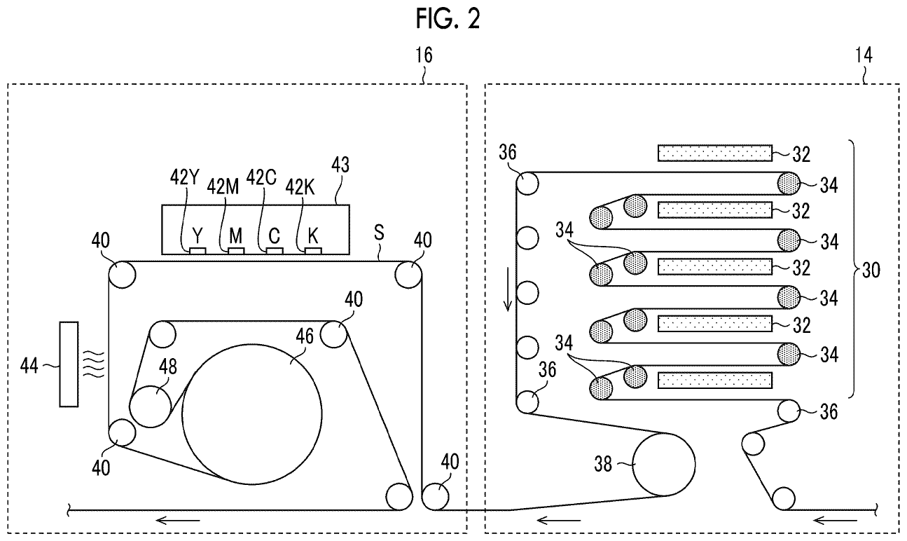

The detailed configurations of the preliminary drying unit 14 and the front surface printing and main drying unit 16 will be described later with reference to FIG. 2. The substrate S discharged from the front surface printing and main drying unit 16 is conveyed to the reversing unit 18.

The reversing unit 18 includes a turn bar (not shown). The turn bar is a reversing mechanism that reverses front and back surfaces of the substrate S. The substrate S of which the front and back surfaces are reversed by the reversing unit 18 is conveyed to the back surface printing and main drying unit 20.

The back surface printing and main drying unit 20 is configured similarly to the front surface printing and main drying unit 16. The back surface printing and main drying unit 20 applies the aqueous ink to the back surface of the substrate S using the print head while conveying the substrate S, thereby forming an image. In addition, the back surface printing and main drying unit 20 performs main drying using the drying device while conveying the substrate S on which the image is formed by the print head. The substrate S discharged from the back surface printing and main drying unit 20 is conveyed to the paper discharge unit 22.

The paper discharge unit 22 comprises a winding roll (not shown) connected to a motor (not shown). The winding roll is rotationally driven by the motor so that the paper discharge unit 22 winds the substrate S on which the image is formed around the winding roll.

The printing apparatus 10 according to the present embodiment preliminarily dries the substrate S before image formation, thereby sufficiently reducing a large amount of moisture contained in the substrate S to be input to the printing apparatus 10. In a case where the moisture in the substrate S is sufficiently dried, the drying transitions from constant-rate drying to a falling-rate drying state, and a change in moisture becomes slower. Therefore, by applying a sufficient heat amount to the substrate S, the moisture in the substrate S can be made constant with a certain degree of accuracy. An adjustment device for adjusting the moisture content and a temperature of the substrate S may be configured by using a heating device for the substrate S, and may be configured by combining the heating device and a cooling device. The preliminary drying unit 14 functions as the adjustment device for adjusting the moisture content and temperature of the substrate S.

As the heating device, a hot air heating unit, a contact heating unit, a radiation heating unit, a dielectric heating unit, or an appropriate combination thereof can be used. Examples of the contact heating unit include a heat roller (heating roller) and a hot plate. Examples of the radiation heating unit include an infrared (IR) heater.

### Configuration Example of Preliminary Drying Unit 14 and Front Surface Printing and Main Drying Unit 16

FIG. 2 is a configuration diagram schematically showing configuration examples of the preliminary drying unit 14 and the front surface printing and main drying unit 16. A heating device 30 applied to the preliminary drying unit 14 is configured by combining hot air units 32 and heat rollers 34. Temperature settings of the hot air units 32 and the heat rollers 34 can be changed. In addition, a path (conveyance path) of the substrate S in the preliminary drying unit 14 can also be changed, and the number of each of hot air units 32 and heat rollers 34 to be installed can be changed depending on the path. As a result, a heating intensity in the preliminary drying unit 14, that is, a drying intensity can be changed. The drying intensity in the preliminary drying may be rephrased as a drying capacity of the preliminary drying unit 14.

FIG. 2 shows an example of the heating device 30 comprising twelve heat rollers 34 and five hot air units 32. In FIG. 2, the heat rollers 34 are shown with a gray fill, and pass rollers 36 is shown in outline (without fill).

In the preliminary drying unit 14, the number of turns in the path using a plurality of the heat rollers 34 and the number of hot air units 32 to be installed are determined according to attributes of the substrate S.

The preliminary drying unit 14 comprises a cooling roller 38 as a cooling device for adjusting the temperature of the substrate S after the preliminary drying by the heating device 30. A pass roller not having a cooling mechanism may be used instead of the cooling roller 38.

The preliminary drying unit 14 is an example of a “substrate moisture reduction unit” and a “first drying device” in the present disclosure.

The front surface printing and main drying unit 16 comprises a plurality of pass rollers 40, print heads 42K, 42C, 42M, and 42Y, a radiation heating unit 44, and a drying cylinder 46.

The plurality of pass rollers 40 are disposed on the conveyance path of the substrate S in the front surface printing and main drying unit 16. The substrate S conveyed into the front surface printing and main drying unit 16 is supported by the pass rollers 40 and is conveyed. Among the plurality of pass rollers 40, one or more pass rollers 40 may function as tension rollers that apply tension to the substrate S. A tension pickup that detects the tension of the substrate S may be disposed on the conveyance path of the substrate S.

The print heads 42K, 42C, 42M, and 42Y are ink jet heads that jet aqueous inks of black (K), cyan (C), magenta (M), and yellow (Y), respectively. The print heads 42K, 42C, 42M, and 42Y are disposed at positions facing the recording surface of the substrate S being conveyed. The recording surface of the substrate S is the front surface of the substrate S in the case of the front surface printing and main drying unit 16. In the case of the back surface printing and main drying unit 20, the recording surface is the back surface of the substrate S.

An image is formed by applying the aqueous ink to the recording surface of the substrate S by the print heads 42K, 42C, 42M, and 42Y. The print heads 42K, 42C, 42M, and 42Y are each configured by a line head capable of forming an image on the substrate S being conveyed by a single scan. The line type print heads 42K, 42C, 42M, and 42Y have a nozzle surface in which a plurality of nozzles, which are outlets for the aqueous ink, are two-dimensionally arranged over a length corresponding to the entire width of the substrate S in the width direction perpendicular to the conveyance direction of the substrate S, and the nozzle surface is disposed to face the recording surface of the substrate S. The print heads 42K, 42C, 42Y, and 42Y are disposed at regular intervals along the conveyance path of the substrate S.

Here, although a configuration in which four colors of ink, cyan, magenta, yellow, and black are used has been described as an example, the combination of ink colors and the number of colors is not limited to the present embodiment, and a light ink, a dark ink, a white ink, a transparent ink, and other special color inks may be added as necessary. A print head corresponding to each ink color may be provided. In addition, the arrangement order of the print heads of the respective ink colors is not limited to the example shown in FIG. 2.

Each of the print heads 42K, 42C, 42M, and 42Y can be configured by connecting a plurality of head modules in the width direction of the substrate S. Each of the print heads 42K, 42C, 42M, and 42Y is supplied with the aqueous ink from an ink tank (not shown) via a pipe path (not shown).

The term “aqueous ink” refers to an ink obtained by dissolving or dispersing a coloring material, such as a dye and a pigment, in water and a solvent soluble in water. Herein, an aqueous pigment ink is used as the aqueous ink. In addition, the aqueous ink may contain wax.

The print heads 42K, 42C, 42Y, and 42Y are housed in a head box 43 and are formed into a unit. The head box 43 comprising the print heads 42K, 42C, 42M, and 42Y corresponds to a printing section that forms an image on the substrate S.

The substrate S on which the image is formed by the print heads 42K, 42C, 42Y, and 42Y is guided by the plurality of pass rollers 40 and conveyed from a position facing the head box 43 to a position facing the radiation heating unit 44.

The radiation heating unit 44 comprises an infrared heater. The infrared heater radiates infrared rays toward the front surface of the substrate S to heat the substrate S. The radiation heating unit 44 may comprise a hot air fan that supplies hot air to the front surface of the substrate S.

The substrate S is guided by the pass rollers 40 and conveyed from the position facing the radiation heating unit 44 to the drying cylinder 46.

The drying cylinder 46 is made of a cylindrical SUS (Steel Use Stainless). The substrate S is wound around an outer peripheral surface of the drying cylinder 46.

The outer peripheral surface of the drying cylinder 46 is heated by a heater (not shown) provided inside. The drying cylinder 46 heats the substrate S by bringing the substrate S into contact with the outer peripheral surface thereof. In addition, a plurality of hot air heaters (not shown) may be disposed around the drying cylinder 46, and a configuration in which hot air is blown from these hot air heaters toward the substrate S wound around the drying cylinder 46 may be adopted. The drying cylinder 46 is rotationally driven about a rotation axis by a motor (not shown). The drying cylinder 46 rotates about the rotation shaft while holding an opposite surface, which is a surface of the substrate S opposite to the recording surface, on the outer peripheral surface, and thus the substrate S is conveyed while being heated from the opposite surface. The opposite surface of the substrate S is the back surface of the substrate S in a case of the front surface printing and main drying unit 16, and is the front surface of the substrate S in a case of the back surface printing and main drying unit 20. The radiation heating unit 44 and the drying cylinder 46 are an example of a “second drying device” in the present disclosure.

The substrate S heated by the drying cylinder 46 is guided by the pass rollers 40 and discharged from the drying cylinder 46 to an outside of the front surface printing and main drying unit 16. In addition, among rollers disposed at positions downstream of the drying cylinder 46 in the conveyance path of the substrate S, in a case where an image formation region (ink application region) of the recording surface of the substrate S that has been subjected to the drying process by the drying cylinder 46 leaves the drying cylinder 46, a first-touch roller 48 that first comes into contact with the image formation region is preferably a cooling roller. The cooling roller has a cooling structure that cools the substrate S that has been subjected to the drying process. A water cooling method in which water adjusted to be in a specified temperature range is circulated as a refrigerant is applied to the cooling structure of the cooling roller.

### [Overview of Operation of Printing Apparatus 10]

The substrate S supplied from the paper feed unit 12 is conveyed to the preliminary drying unit 14 and is preliminarily dried. The preliminary drying unit 14 heats the substrate S to bring the substrate S into a falling-rate drying state. The preliminarily dried substrate S is conveyed to the front surface printing and main drying unit 16.

In the front surface printing and main drying unit 16, the substrate S is guided by the pass rollers 40 and conveyed to the positions facing the print heads 42K, 42C, 42Y, and 42Y The print heads 42K, 42C, 42Y, and 42Y jet liquid droplets of the aqueous ink toward the front surface of the substrate S. The jetted liquid droplets adhere to the front surface of the substrate S, thereby forming an image on the front surface of the substrate S. The front surface of the substrate S is an example of a “first surface” in the present disclosure. The print heads 42K, 42C, 42Y, and 42Y in the front surface printing and main drying unit 16 are an example of a “first print head” in the present disclosure.

Subsequently, the substrate S is conveyed to the position facing the radiation heating unit 44. The radiation heating unit 44 heats the substrate S using the infrared heater. In this manner, the drying of the aqueous ink applied to the front surface of the substrate S is promoted.

Further, the substrate S is guided by the pass rollers 40 and conveyed to the drying cylinder 46 from the position facing the radiation heating unit 44. The substrate S is wound around an outer peripheral surface of the drying cylinder 46. The drying cylinder 46 rotates while bringing the outer peripheral surface into contact with the back surface of the substrate S, thereby conveying the substrate S while heating the substrate S from the back surface. In this manner, the drying of the aqueous ink applied to the front surface of the substrate S is promoted.

The substrate S on which the aqueous ink applied to the front surface is dried is discharged to the outside of the front surface printing and main drying unit 16.

The substrate S discharged from the front surface printing and main drying unit 16 is conveyed to the reversing unit 18, and the front and back surfaces thereof are reversed by the turn bar. The substrate S of which the front and back surfaces are reversed is conveyed to the back surface printing and main drying unit 20.

In the back surface printing and main drying unit 20, the substrate S is guided by the pass rollers 40 and conveyed to the positions facing the print heads 42K, 42C, 42Y, and 42Y. The print heads 42K, 42C, 42Y, and 42Y jet liquid droplets of the aqueous ink toward the back surface of the substrate S. The jet liquid droplets adhere to the back surface of the substrate S, thereby forming an image on the back surface of the substrate S. The back surface of the substrate S is an example of a “second surface” in the present disclosure. The print heads 42K, 42C, 42Y, and 42Y in the back surface printing and main drying unit 20 are an example of a “second print head” in the present disclosure.

Subsequently, the substrate S is conveyed to the position facing the radiation heating unit 44. The radiation heating unit 44 heats the substrate S using the infrared heater. In this manner, the drying of the aqueous ink applied to the back surface of the substrate S is promoted.

Further, the substrate S is guided by the pass rollers 40 and conveyed to the drying cylinder 46 from the position facing the radiation heating unit 44. The substrate S is wound around an outer peripheral surface of the drying cylinder 46. The drying cylinder 46 rotates while bringing the outer peripheral surface into contact with the front surface of the substrate S, thereby conveying the substrate S while heating the substrate S from the front surface. In this manner, the drying of the aqueous ink applied to the back surface of the substrate S is promoted.

The substrate S on which the aqueous ink applied to the back surface is dried is discharged to an outside of the back surface printing and main drying unit 20. The substrate S discharged from the back surface printing and main drying unit 20 is conveyed to the paper discharge unit 22 and is wound around the winding roll.

As described above, the printing apparatus 10 conveys the substrate S in the order of the paper feed unit 12, the preliminary drying unit 14, the front surface printing and main drying unit 16, the reversing unit 18, the back surface printing and main drying unit 20, and the paper discharge unit 22, thereby performing each process on the substrate S to manufacture printed matter. A printing method executed by the printing apparatus 10 is understood as a method of manufacturing printed matter.

### <Need for Adjusting Absolute Humidity in Periphery of Nozzle Surface>

In the printing apparatus 10 according to the present embodiment, before image formation by the print heads 42K, 42C, 42M, and 42Y, the preliminary drying of the substrate S and the adjustment of the absolute humidity in the periphery of the nozzle surface are introduced, thereby achieving an improvement of drying performance, suppression of substrate deformation, and suppression of jetting failure.

Reducing the moisture content of the substrate S before image formation (preliminary drying) is effective in terms of improving drying performance and suppressing deformation of the substrate. By reducing the moisture inside the substrate S, thermal conductivity of the substrate S is increased and the drying performance is improved. In addition, by reducing moisture in a pulp layer of the substrate S, it is possible to avoid a local wet state even after image formation. In a case of the back surface printing, the moisture in the substrate S is reduced by the drying after the front surface printing, and thus the preliminary drying may be performed only before the front surface printing. Compared to an apparatus configuration in which similar drying devices are installed before both the front surface printing and the back surface printing, the number of drying devices can be reduced, and the cost can be reduced.

While such preliminary drying before image formation has a great effect, there is a problem in that the jetting failure of the print heads 42K, 42C, 42M, and 42Y is likely to occur. As a countermeasure, the printing apparatus 10 is provided with a unit that adjusts the absolute humidity in the periphery of the head. In a case of a double-sided printing machine, the periphery of the nozzle surface of the print head for back surface printing is likely to become moist due to an influence of an image area of the front surface of the substrate S on which the image is formed on the front surface, and thus the unit that adjusts the absolute humidity may be introduced only in the printing section for front surface printing.

### Example of Relationship Between Preliminary Drying, Absolute Humidity, and Printing Result

As described above, while the introduction of the preliminary drying unit 14 to the printing apparatus 10 improves drying properties such as white spots, preliminary drying of the substrate S may result in a drawback in that the ink in the nozzles of the print heads 42K, 42C, 42M, and 42Y thickens and deteriorates. Therefore, it is preferable to specify conditions of the periphery of the nozzle surface and take measures against the jetting failure in addition to the preliminary drying of the substrate S.

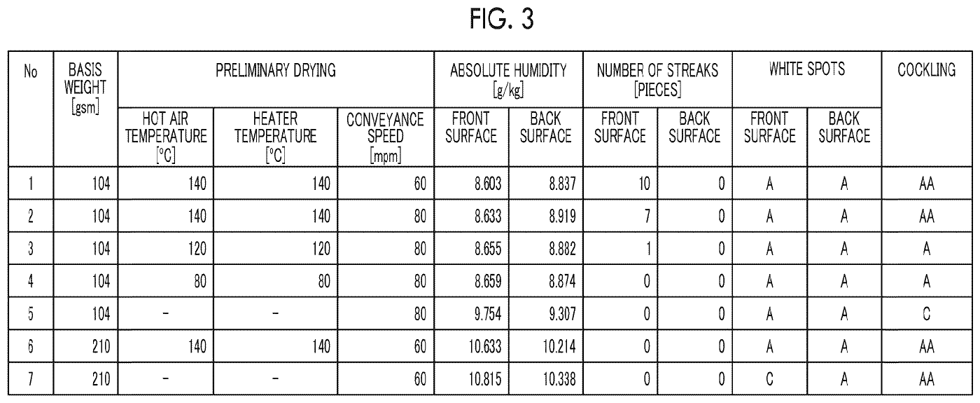

FIG. 3 is a data table showing results of an experiment obtained by examining a relationship between a basis weight of the substrate S, each drying condition in the preliminary drying unit 14, the number of streaks occurring on the printed matter, the occurrence status of white spots, and the occurrence status of cockling. As conditions for the preliminary drying, the experiment was conducted by changing settings of a hot air temperature, a heater temperature, and the conveyance speed of the substrate S. The hot air temperature is the temperature of the hot air unit 32. The heater temperature is the temperature of the heat roller 34.

In this experiment, a radiation heating temperature for main drying (main drying) of each of the front surface printing and main drying unit 16 and the back surface printing and main drying unit 20 is 80° C., the drying cylinder 46 and the hot air temperature are both 140° C., and an environmental humidity is 55%. Paper types of the substrate S used in the experiment include OK TopKote (manufactured by Oji Paper Co., Ltd., “TopKote” is a registered trademark), which is thin paper having a basis weight of 104 [grams per square meter (gsm)], and Bon Ivory (manufactured by Oji Paper Co., Ltd., “Bon Ivory” is a registered trademark), which is thick paper having a basis weight of 210 [gsm]. Each of these different types of substrates S was evaluated. The amount of ink droplets jetted from the nozzle is 3.15 pL (picoliters), and no pretreatment liquid is applied to the substrate S before the application of the ink.

In the printing apparatus 10 according to the present embodiment, the ink is jetted onto the substrate S in the order of K, C, M, and Y to form an image. A value of the absolute humidity is an average of measured values taken at three points in the width direction upstream of the nozzle surface of the most upstream print head 42K (near the K head). Since a humidity downstream of the head is higher than a humidity upstream of the head due to the ink being jetted to the substrate S, it is basically sufficient to specify the absolute humidity upstream of the head that is disposed most upstream among a plurality of the print heads 42K, 42C, 42M, and 42Y.

FIG. 3 shows an experimentally obtained relationship between the absolute humidity in the periphery of the nozzle surface under each drying condition and the number of streaks, white spots, and cockling that occur on the printed matter due to jetting failure. In FIG. 3, the evaluation of the occurrence of the white spots and the cockling was determined by a four-level sensory evaluation as follows.
AA: Very good
A: Good
B: Acceptable
C: Unacceptable

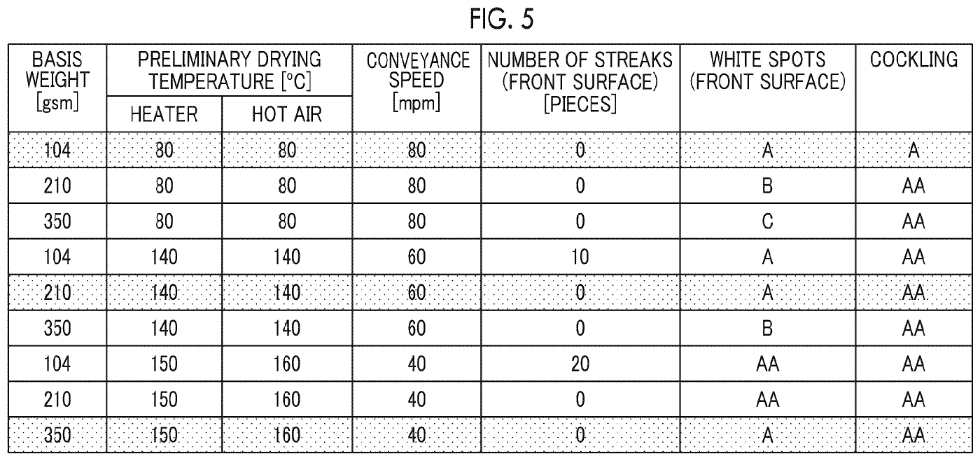

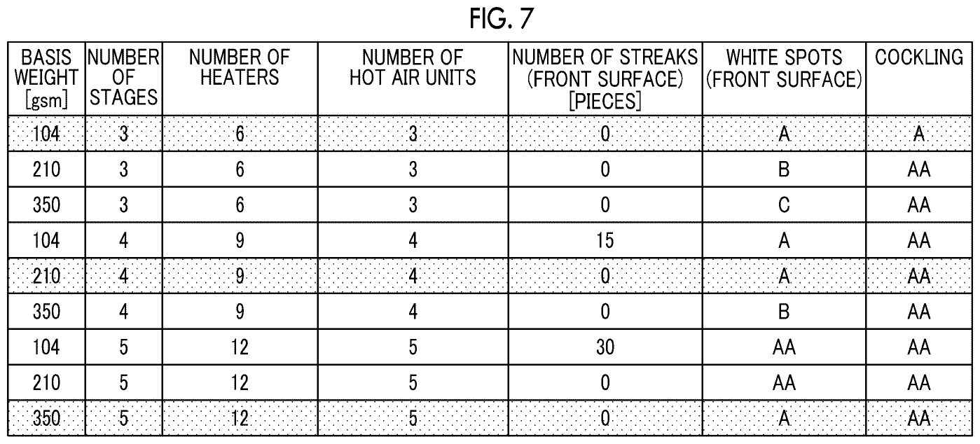

Ratings of AA, A, and B are considered acceptable, while a rating of C is considered unacceptable. It should be noted that this evaluation method is similarly applied to FIGS. 5 and 7 described later.

From the experimental results shown in FIG. 3, it can be seen that the absolute humidity changes depending on the preliminary drying intensity and the basis weight of the substrate S, and the degree of white spots or streaks changes accordingly. As the preliminary drying intensity increases and the basis weight of the substrate S decreases, the substrate S is more easily dried, which is good for suppressing white spots and cockling, but streaks are likely to occur because the absolute humidity in the periphery of the nozzle surface decreases.

That is, it can be seen that, among the conditions of Experiment Nos. 1 to 7 shown in FIG. 3, the conditions of Experiment Nos. 1 to 3, which are conditions in which the preliminary drying intensity is high, are effective against white spots and cockling, but streaks occur due to jetting failure. Contrary to this, under the conditions of Experiment No. 4, which are conditions in which the preliminary drying intensity is low, all items of the number of streaks, white spots, and cockling are at the pass level due to the increase in absolute humidity in the periphery of the nozzle surface. On the other hand, it is also a fact that the conditions of Experiment No. 4 is one step lower in the cockling performance from the rating of AA to the rating of A compared to the conditions of Experiment Nos. 1 and 2, and there is room for further improvement.

In any case, it is important to adjust the absolute humidity in the periphery of the nozzle surface as a measure against streaks.

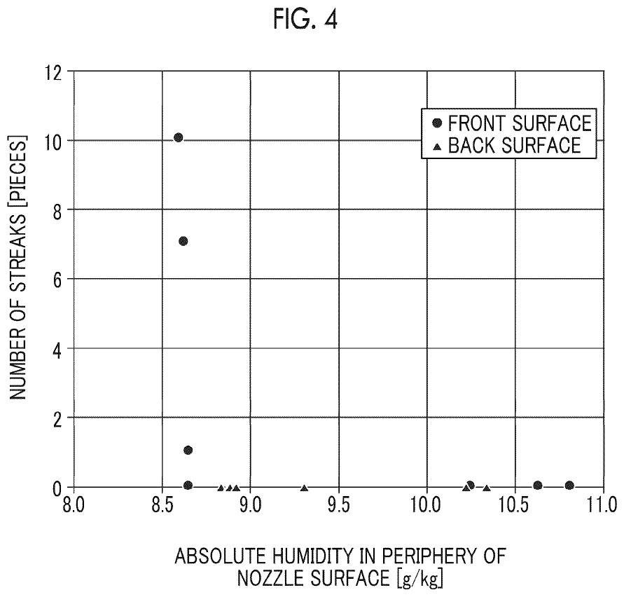

FIG. 4 is a graph showing a relationship between the absolute humidity in the periphery of the nozzle surface and the number of streaks. As shown in FIG. 4, it can be seen that streaks are likely to occur on the front surface, and streaks are less likely to occur on the back surface.

In addition, in a case where the absolute humidity is less than 8.665, the number of streaks rapidly increases.

For this reason, in order to suppress streaks, it is effective to adjust the absolute humidity of the periphery of the nozzle surfaces of the print heads 42K, 42C, 42M, and 42Y that form the image on the front surface.

### Absolute Humidity Adjustment Method

In the printing apparatus 10 according to the present embodiment, the three problems of white spots, cockling, and streaks are solved by introducing the preliminary drying of the substrate S and the adjustment of the absolute humidity in the periphery of the nozzle surface of the print head 42K before image formation. Examples of a specific absolute humidity adjustment method are as follows.

### [Method 1: Adjustment of Preliminary Drying Intensity]

As described above, from the experimental results shown in FIG. 3, by changing the preliminary drying intensity according to the basis weight of the substrate S, the moisture content of the substrate changes, and thus the absolute humidity can be adjusted. For example, in the case of the thin paper (basis weight 104 gsm), streaks occur under each of the conditions of Experiment Nos. 1 to 3, but as in the case of Experiment No. 4, streaks can be suppressed by lowering the hot air temperature and the heater temperature in the preliminary drying to 80° C. That is, the preliminary drying intensity corresponding to the basis weight of the substrate S may be set, and as a result, the absolute humidity in the periphery of the nozzle surface is adjusted to an appropriate range.

In the printing apparatus 10 according to the present embodiment, an appropriate absolute humidity is achieved by changing the hot air temperature of the hot air unit 32, the temperature of the heat roller 34, and the conveyance speed of the substrate S in the preliminary drying unit 14 to appropriate values according to the basis weight of the substrate S.

FIG. 5 is a data table showing results of an experiment obtained by examining the number of streaks and the occurrence statuses of white spots and cockling in a case where the combination of the basis weight of the substrate S and the preliminary drying conditions is changed. In the preliminary drying unit 14 of the printing apparatus 10 used in this experiment, the number of stages of preliminary drying is 5, the number of heat rollers 34 is 12, and the number of hot air units 32 is 5. The term “heater” in FIG. 5 means the heat roller 34.

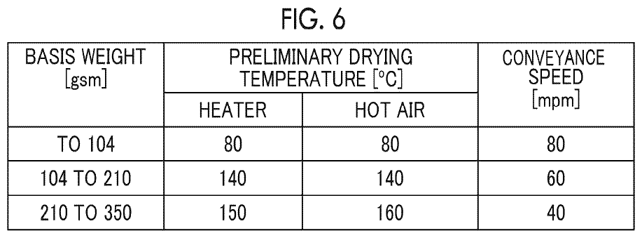

From the experimental results shown in FIG. 5, in a case where appropriate preliminary drying conditions (preliminary drying intensity) according to the basis weight are extracted, a table as shown in FIG. 6 can be obtained. FIG. 6 is a table showing an example of setting of the preliminary drying conditions with respect to the basis weight of the substrate S. As shown in FIG. 6, the preliminary drying intensity is set to be higher as the basis weight of the substrate S is larger.

In the printing apparatus 10, the drying conditions in the preliminary drying unit 14 may be changed according to the basis weight of the substrate S to be used, based on the table shown in FIG. 6. As described above, values such as temperatures determined in advance based on experiments may be applied to the drying conditions for the preliminary drying according to the basis weight of the substrate S. Alternatively, a user may freely adjust the values of the drying conditions for the preliminary drying according to specific conditions.

As described in FIGS. 5 and 6, the method is not limited to storing the relationship between the basis weight and the set values of the preliminary drying intensity as a table based on experiments and changing the preliminary drying intensity according to the basis weight, and the heat amount applied to the substrate S may be adjusted by changing the conveyance path (path) of the substrate S in the preliminary drying unit 14. By adopting a configuration in which the path can be flexibly changed in addition to changing the drying temperature, the drying conditions according to usage conditions of the user can be applied.

FIG. 7 is a data table showing results of an experiment obtained by examining the number of streaks and the occurrence statuses of white spots and cockling in a case where the combination of the basis weight of the substrate S and a preliminary drying path is changed. The preliminary drying path is a substrate conveyance path of the preliminary drying unit 14, and the path can be changed by changing the number of hot air units 32 and the number of heat rollers 34 shown in FIG. 2. The term “number of heaters” in FIG. 7 means the number of heat rollers 34. In this experiment, the heater temperature is 150° C., the hot air temperature is 160° C., and the conveyance speed is 40 mpm (miles per minute).

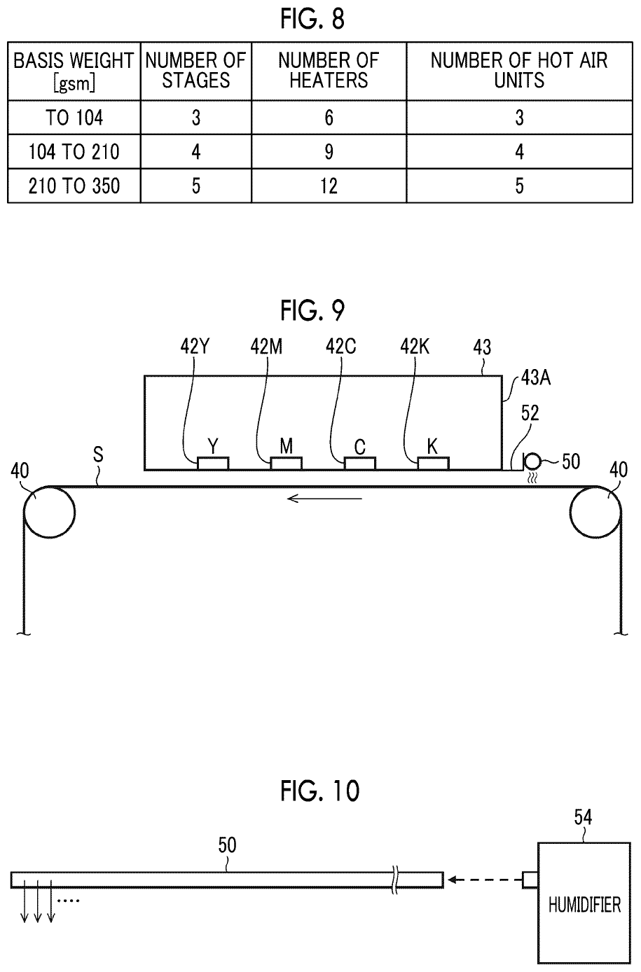

From the experimental results shown in FIG. 7, in a case where an appropriate preliminary drying path according to the basis weight is extracted, a table as shown in FIG. 8 can be obtained. FIG. 8 is a table showing an example of setting of the preliminary drying path with respect to the basis weight of the substrate S. Based on the table shown in FIG. 7, an appropriate preliminary drying path in the preliminary drying unit 14 is selected according to the basis weight of the substrate S to be used.

A configuration of changing the drying intensity and/or the preliminary drying path for the preliminary drying according to the basis weight of the substrate S is an example of an “absolute humidity adjustment unit” in the present disclosure.

### [Method 2: Introduction of Humidifier]

In principle, the occurrence of streaks is suppressed by increasing the absolute humidity of an atmosphere in the periphery of the nozzle surface, and thus a humidification source that supplies humidified air to the periphery of the nozzle surface may be introduced. A location (installation position) where the humidification source is disposed is preferably between the preliminary drying unit 14 and the head box 43, but a function of freely adjusting the position of the humidification source may be provided.

Specific examples of a form and the installation position of the humidification source include Form Examples 1 to 3 shown below.

### Form Example 1

FIGS. 9 and 10 are explanatory diagrams showing Form Example 1 of the humidification source. The printing apparatus 10 may comprise a tube 50 as a humidification source upstream of the head box. The tube 50 has, for example, an outer diameter of 8 mm and an inner diameter of 5 mm, and is disposed to face the substrate S in parallel with the print head 42K along the width direction of the print head 42K. The tube 50 has a plurality of holes, each having a hole diameter of, for example, 0.2 mm to 0.3 mm, spaced at pitch intervals of 8 mm along a length direction of the tube 50. The 8 mm pitch interval is an example of a “specific pitch interval” in the present disclosure.

A humidifier 54 is installed outside the printing apparatus 10, and the humidifier 54 is connected to the tube 50 via a pipe (not shown) (see FIG. 10). Humidified air sent out from the humidifier 54 is sent to a periphery of the print head 42K through the tube 50. The humidified air flowing out of the plurality of holes in the tube 50 humidifies the periphery the print head 42K.

FIG. 9 shows an example in which the tube 50 is fixed to a wall frame 43A upstream of the head box 43 via a support member 52, but the tube 50 may be disposed inside the head box 43.

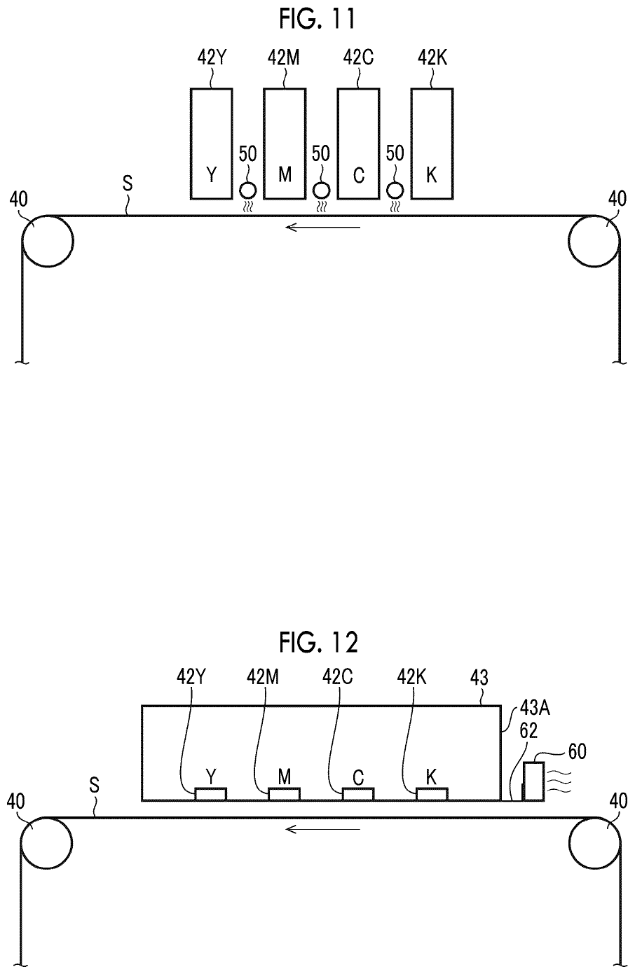

In addition, instead of the configuration shown in FIG. 9 or in addition to the configuration shown in FIG. 9, the tube 50 of the humidification source may be provided between the heads of the plurality of print heads 42K, 42C, 42M, and 42Y as shown in FIG. 11. The number and disposition positions of tubes 50 are not limited to the examples of FIGS. 9 and 11. For example, the tube 50 may be disposed only between the two upstream print heads 42K and 42C in the head box 43, or the tube 50 may be disposed only upstream of the print head 42K in the head box 43.

### Form Example 2

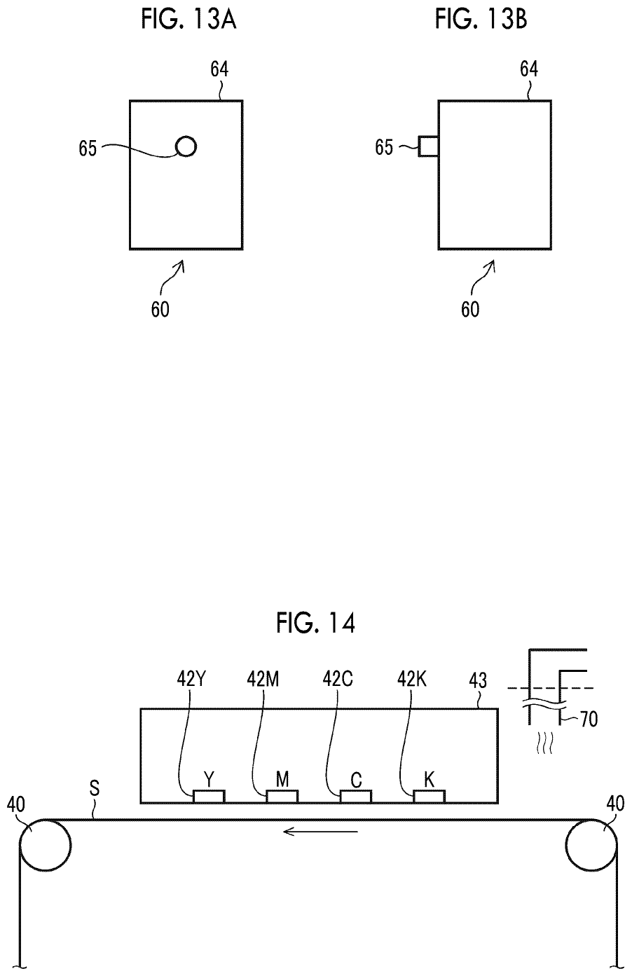

FIGS. 12 to 13B are explanatory diagrams showing Form Example 2 of the humidification source. As shown in FIG. 12, the printing apparatus 10 may comprise a humidifier 60 as the humidification source upstream of the head box 43. The humidifier 60 is fixed to the wall frame 43A upstream of the head box 43 via a support member 62. FIG. 13A is a front view of the humidifier 60, and FIG. 13B is a side view of the humidifier 60. The humidifier 60 is, for example, an ultrasonic humidifier having an outer shape of a size of 70 mm×70 mm×140 mm. The humidifier 60 comprises a tank 64 that generates humidified air and a nozzle 65 that is an outlet of the humidified air. A humidification direction (a direction in which humidified air is sent out) may be changed by changing a direction of the nozzle 65.

### Form Example 3

FIG. 14 is an explanatory diagram showing Form Example 3 of the humidification source. As shown in FIG. 14, the printing apparatus 10 may comprise a duct 70 as the humidification source upstream of the head box 43. An outer diameter of the duct 70 is, for example, 100 mm. A humidifier (not shown) is installed outside the printing apparatus 10, and the humidifier is connected to the duct 70 via a pipe (not shown). Humidified air sent out from the humidifier is supplied to the periphery of the head through the duct 70. The periphery of the head is humidified by the humidified air flowing out from an opening of the duct 70.

### [Adjustment of Humidification Amount]

In each of Form Examples 1 to 3, the humidification amount may be further adjusted, and as a method of controlling the humidification amount, for example, the following methods are available.

### Example 1 of Control Method

The printing apparatus 10 may adjust the humidification amount according to the basis weight of the substrate S. The term “adjustment of the humidification amount” also includes adjustment of not performing humidification (no humidification). As the humidification amount set according to the basis weight, a value experimentally obtained in advance is used.

### Example 2 of Control Method

The printing apparatus 10 may comprise a measuring instrument (not shown) that measures a temperature and a humidity in the periphery of the head, and may be configured to constantly monitor the absolute humidity calculated from values of the temperature and relative humidity obtained from the measuring instrument, and adjust the humidification amount in a case where the absolute humidity is equal to or less than a certain threshold value. In this case, the threshold value may be determined from a value of absolute humidity at which the number of streaks starts to rapidly increase, which has been experimentally confirmed, as described in FIG. 5. In addition, the printing apparatus 10 may comprise a measuring instrument that can measure the absolute humidity in the periphery of the head.

The configuration of adjusting the absolute humidity using the humidification source is an example of the “absolute humidity adjustment unit” in the present disclosure. As described above, the reason why the drying performance is increased by preliminary drying is that heat transfer properties of the substrate S are improved due to the reduction in moisture inside the substrate S. Therefore, even in a case where moisture in the air due to the atmospheric humidification adheres to the front surface of the substrate S, the moisture content inside the substrate S is not restored, and the original benefit of improved drying performance is not impaired. That is, by the combination of the preliminary drying before image formation and the adjustment of the absolute humidity in the periphery of the nozzle surface, it is possible to achieve a nozzle surface humidity at which the jetting failure can be suppressed while satisfying the effect of improving the heat transfer properties of the substrate S.

### [Method 3: Adjustment of Exhaust Amount]

The absolute humidity in the periphery of the nozzle surface may be adjusted by adjusting an exhaust amount of the dry air from an inside of the printing apparatus 10 and taking in humid outside air to the inside. In this case, from the viewpoint of cost reduction, the exhaust may be reused by hot air drying or the like.

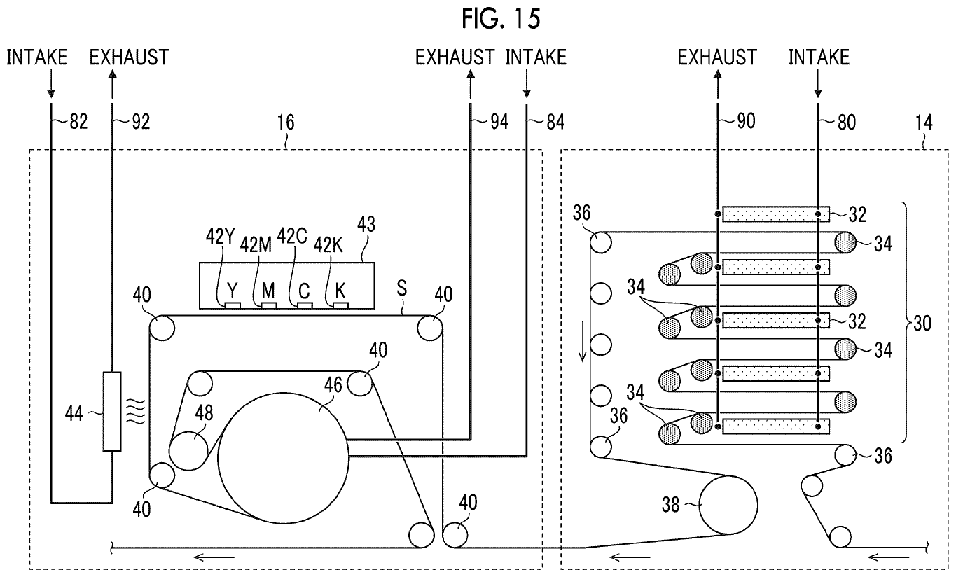

FIG. 15 is a configuration diagram schematically showing an example of an intake and exhaust structure applied to the printing apparatus 10. The preliminary drying unit 14 is provided with an intake flow passage 80 and an exhaust flow passage 90. The intake flow passage 80 is connected to the hot air units 32 and supplies the outside air to each hot air unit 32. The exhaust flow passage 90 has an exhaust hole near a downstream side of each hot air unit 32, suctions inside air from the exhaust hole, and discharges the air to the outside.

The front surface printing and main drying unit 16 is provided with intake flow passages 82 and 84 and exhaust flow passages 92 and 94. The intake flow passage 82 supplies humid outside air to the vicinity of a downstream side of the radiation heating unit 44. The exhaust flow passage 92 suctions the inside air from the vicinity of an upstream side of the radiation heating unit 44 and discharges the suctioned air to the outside.

In addition, the intake flow passage 84 supplies humid outside air to the drying cylinder 46. The exhaust flow passage 94 suctions the inside air from the drying cylinder 46 and discharges the suctioned air to the outside. A blower (not shown) is connected to the exhaust flow passages 92 and 94. An intake amount is adjusted by adjusting the exhaust amount. The intake flow passages 82 and 84 are an example of an “intake unit” in the present disclosure, and the exhaust flow passages 92 and 94 and the blower (not shown) are an example of an “exhaust unit” in the present disclosure. The configuration of adjusting the absolute humidity by the intake and exhaust structure shown in FIG. 15 is an example of the “absolute humidity adjustment unit” in the present disclosure.

Methods 1 to 3 related to the adjustment of the absolute humidity may be appropriately combined.

### [Need for Measures Against Front Surface Printing in Double-Sided Printing Apparatus]

From the experimental results shown in FIG. 3, it can be seen that white spots and streaks are unlikely to occur on the back surface of the substrate S. The reason why white spots do not occur is considered to be that, in a case of the back surface printing, the moisture content inside the substrate S is sufficiently reduced by drying the front surface, and thus heat transfer performance is improved. The reason why streaks do not occur is considered to be that the absolute humidity of the atmosphere is not likely to decrease due to the wet image area of the front surface being conveyed. This means that it is not necessary to introduce a preliminary drying unit or an absolute humidity adjustment unit between front surface printing and back surface printing, which leads to a reduction in size and cost of the apparatus.

### [Other Additional Configurations]

In order to prevent mist due to static charge on the substrate S during preliminary drying, the substrate S may be electrically discharged. As a specific method, for example, an electrostatic elimination device such as an ionizer or an electrostatic eliminator brush may be disposed on the substrate conveyance path between the preliminary drying unit 14 and the head box 43.

### Example 1 of Electrical Configuration of Printing Apparatus 10

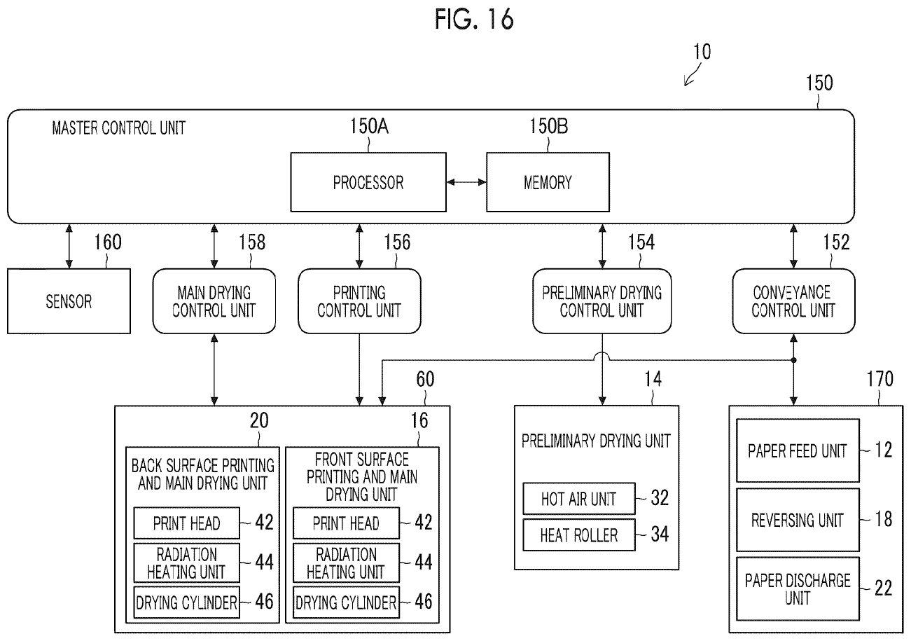

FIG. 16 is a functional block diagram showing Example 1 of an electrical configuration of the printing apparatus 10. The printing apparatus 10 comprises a master control unit 150, a conveyance control unit 152, a preliminary drying control unit 154, a printing control unit 156, and a main drying control unit 158. In addition, the printing apparatus 10 comprises various sensors 160. The sensor 160 may include a measuring instrument such as a thermo-hygrometer or absolute hygrometer for measuring the absolute humidity in the periphery of the nozzle surface of the print head 42K.

The master control unit 150 performs overall control of the printing apparatus 10. The master control unit 150 includes a processor 150A and a memory 150B. The processor 150A may be, for example, a central processing unit (CPU). The processor 150A executes a command stored in the memory 150B.

The memory 150B stores the command to be executed by the processor 150A. The memory 150B includes a random access memory (RAM) and a read only memory (ROM). The processor 150A uses the RAM as a work area and executes software using various programs and parameters stored in the memory 150B to perform various processes for controlling the printing apparatus 10. The master control unit 150 transmits command signals to various control units based on information obtained from the sensors 160, and controls an operation of each unit via the various control units.

The conveyance control unit 152 controls a conveyance mechanism 170 for the substrate S. The conveyance mechanism 170 includes the paper feed unit 12, the reversing unit 18, and the paper discharge unit 22. The conveyance control unit 152 controls the motor of the paper feed unit 12, the turn bar of the reversing unit 18, and the motor of the paper discharge unit 22 to apply a predetermined conveyance tension to the substrate S and convey the substrate S at a predetermined conveyance speed. In addition, the conveyance control unit 152 controls the rotational driving of the drying cylinder 46 of each of the front surface printing and main drying unit 16 and the back surface printing and main drying unit 20.

The preliminary drying control unit 154 controls the hot air units 32 and the heat rollers 34 of the preliminary drying unit 14 to preliminarily dry the substrate S.

The printing control unit 156 controls each print head 42 of the front surface printing and main drying unit 16 and the back surface printing and main drying unit 20 to form an image on the substrate S. The print head 42 shown in FIG. 16 collectively represents the plurality of print heads 42K, 42C, 42M, and 42Y shown in FIG. 2. The printing control unit 156 comprises an image processing unit that generates a halftone image of a print image from print data, and a correction processing unit that performs various correction processes. The printing control unit 156 comprises a drive voltage generation unit that generates a drive voltage to be supplied to the print head 42 based on dot arrangement information and dot size information based on the halftone image, and a drive voltage supply circuit that supplies the drive voltage.

The main drying control unit 158 controls the radiation heating unit 44 and the drying cylinder 46 of each of the front surface printing and main drying unit 16 and the back surface printing and main drying unit 20 to dry (mainly dry) the aqueous ink applied to the substrate S.

### Example 2 of Electrical Configuration of Printing Apparatus 10

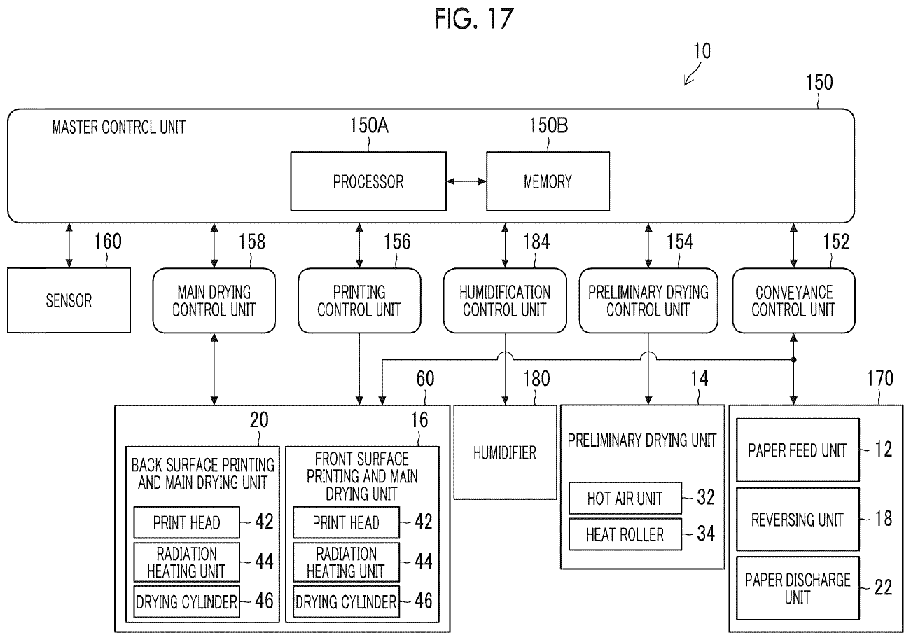

FIG. 17 is a functional block diagram showing Example 2 of the electrical configuration of the printing apparatus 10. A difference in the configuration shown in FIG. 17 from FIG. 16 will be described. In FIG. 17, the same elements as those in the configuration shown in FIG. 16 are denoted by the same reference numerals, and the duplicate description will be omitted.

The printing apparatus 10 shown in FIG. 17 comprises a humidifier 180 and a humidification control unit 184. The humidifier 180 may be the humidifier 54 described in FIG. 10, the humidifier 60 described in FIG. 12, or the humidifier connected to the duct 70 described in FIG. 14. The humidification control unit 184 controls the humidifier 60 to adjust the humidification amount. The master control unit 150 and the humidification control unit 184 control the humidification amount according to the basis weight of the substrate S. In addition, the master control unit 150 and the humidification control unit 184 may control the humidification amount based on the information on the absolute humidity obtained from the sensors 160. Other configurations may be similar to those shown in FIG. 16.

### Example 3 of Electrical Configuration of Printing Apparatus 10

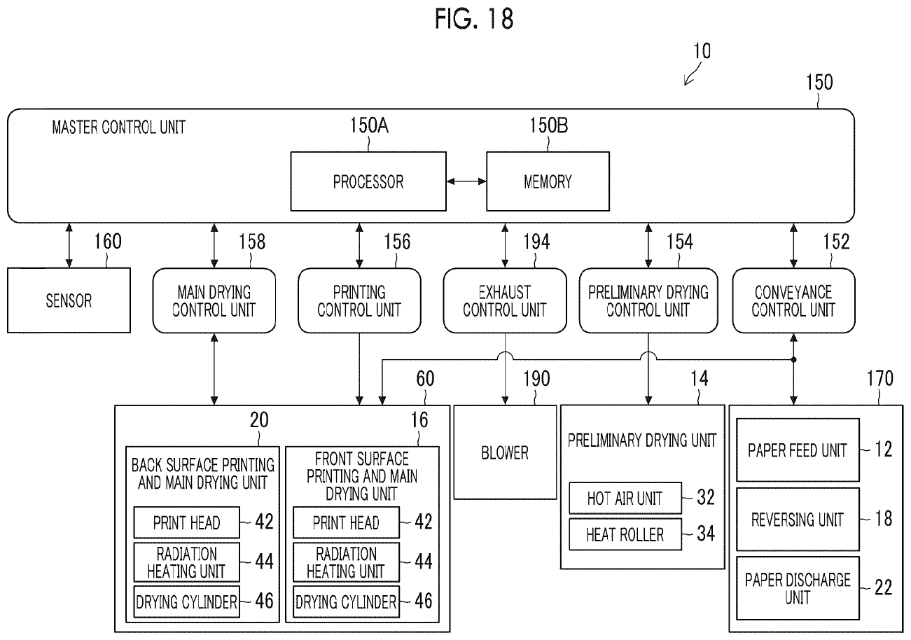

FIG. 18 is a functional block diagram showing Example 3 of the electrical configuration of the printing apparatus 10. A difference of the configuration shown in FIG. 18 from FIG. 16 will be described. In FIG. 18, the same elements as those in the configuration shown in FIG. 16 are denoted by the same reference numerals, and the duplicate description thereof will be omitted.

The printing apparatus 10 shown in FIG. 18 comprises a blower 190 for exhaust and an exhaust control unit 194. The blower 190 includes the blowers connected to the exhaust flow passages 90, 92, and 94 described in FIG. 15. The exhaust control unit 194 controls the blower 190 to adjust the exhaust amount. Other configurations may be similar to those shown in FIG. 16.

In the configuration shown in FIG. 18, the humidifier 180 and the humidification control unit 184 described in FIG. 17 may be further provided.

### Example of Hardware Configuration of Control Device

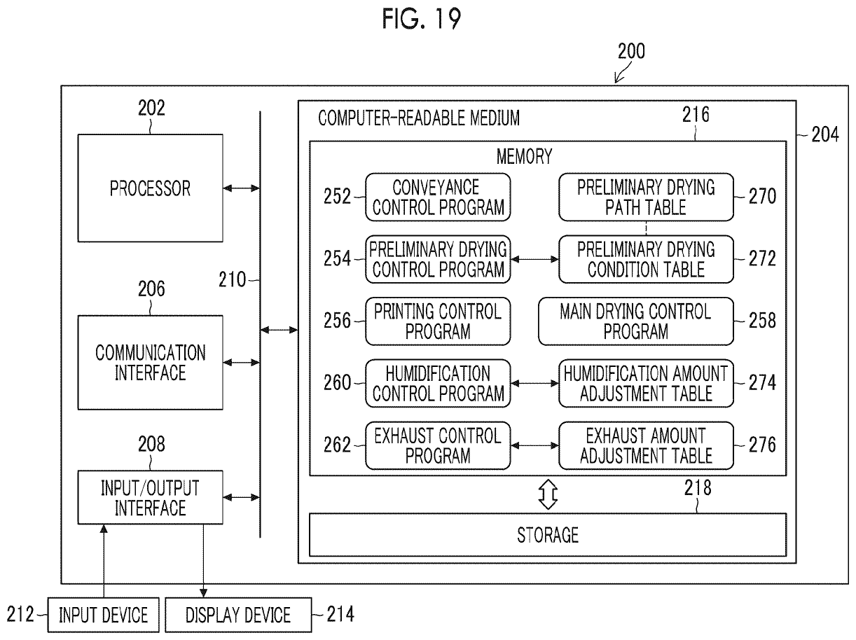

FIG. 19 is a block diagram showing an example of a hardware configuration of an information processing device 200 that functions as a control device of the printing apparatus 10. The information processing device 200 is configured by a combination of hardware and software of a computer. The computer may be a server, a personal computer, a workstation, a tablet terminal, or the like and may be in any physical form. The information processing device 200 comprises a processor 202, a computer-readable medium 204, a communication interface 206, an input/output interface 208, and a bus 210.

The processor 202 includes a CPU. The processor 202 may include a graphics processing unit (GPU). The processor 202 is connected to the computer-readable medium 204, the communication interface 206, and the input/output interface 208 via the bus 210.

The computer-readable medium 204 includes a memory 216 that is a main storage device and a storage 218 that is an auxiliary storage device. The storage 218 may be, for example, a hard disk drive (HDD) device, a solid-state drive (SSD) device, or a combination thereof. In addition, the computer-readable medium 204 may include a ROM. A part or all of a storage region of the computer-readable medium 204 may be included in the processor 202.

The processor 202 and the memory 216 function as the processor 150A and the memory 150B described in FIG. 16.

The computer-readable medium 204 stores a program, data, and the like for implementing a control function of the printing apparatus 10. The term “program” includes the concept of a program module. The computer-readable medium 204 stores various programs such as a conveyance control program 252, a preliminary drying control program 254, a printing control program 256, a main drying control program 258, a humidification control program 260, and an exhaust control program 262. In addition, data such as a preliminary drying path table 270, a preliminary drying condition table 272, a humidification amount adjustment table 274, and an exhaust amount adjustment table 276 are stored in the computer-readable medium 204.

The conveyance control program 252 is a program including a command for implementing the function of the conveyance control unit 152 shown in FIG. 16. The preliminary drying control program 254 is a program including a command for implementing the function of the preliminary drying control unit 154. The printing control program 256 and the main drying control program 258 are programs including commands for implementing the functions of the printing control unit 156 and the main drying control unit 158, respectively. The humidification control program 260 is a program including a command for implementing the function of the humidification control unit 184 shown in FIG. 17. The exhaust control program 262 is a program including a command for implementing the function of the exhaust control unit 194 shown in FIG. 18. The preliminary drying path table 270 is, for example, the table as shown in FIG. 8, and specifies a preliminary drying path set in accordance with the basis weight of the substrate S. The processor 202 can display the information of the preliminary drying path table 270 on a display device 214 as necessary, such as in a case where the basis weight of the substrate S to be used is changed, and present information prompting the user to change the preliminary drying path to a preliminary drying path suitable for the basis weight of the substrate S.

The preliminary drying condition table 272 is, for example, the table as shown in FIG. 6, and specifies preliminary drying condition (preliminary drying intensity) set in accordance with the basis weight of the substrate S. The preliminary drying control program 254 sets the preliminary drying intensity according to the basis weight of the substrate S based on the preliminary drying condition table 272. The preliminary drying path table 270 and the preliminary drying condition table 272 may be integrated.

The humidification amount adjustment table 274 specifies the humidification amount set in accordance with the basis weight of the substrate S. The humidification amount adjustment table 274 may be created based on an experiment. The humidification control program 260 adjusts the humidification amount according to the basis weight of the substrate S based on the humidification amount adjustment table 274.

The exhaust amount adjustment table 276 specifies the exhaust amount set in accordance with the basis weight of the substrate S. The exhaust amount adjustment table 276 may be created based on an experiment. The exhaust control program 262 adjusts the exhaust amount according to the basis weight of the substrate S based on the exhaust amount adjustment table 276.

In FIG. 19, an example of the information processing device 200 having the humidification control function and the exhaust control function is shown. However, a form in which the humidification control function and the exhaust control function are not provided is also possible (see FIG. 16), and a form in which, as shown in FIG. 17 or FIG. 18, only one of the humidification control function or the exhaust control function is provided is also possible. A necessary program and data are stored in the computer-readable medium 204 in accordance with the functions implemented in the printing apparatus 10.

The processor 202 executes the commands of the programs stored in the computer-readable medium 204 to implement various types of control and processes. Some of processing functions of the information processing device 200 may be implemented by using an integrated circuit represented by a digital signal processor (DSP) or a field programmable gate array (FPGA).

In addition, although not shown in FIG. 19, a display control program is stored in the computer-readable medium 204. The display control program is a program including a command for implementing a function of generating a display signal required for display output to the display device 214 and performing display control of the display device 214.

The communication interface 206 performs communication processing with an external device in a wired or a wireless communication manner to exchange information with the external device. The information processing device 200 is connected to a communication line (not shown) via the communication interface 206. The communication line may be a local area network or a wide area network.

The information processing device 200 is connected to an input device 212 and the display device 214 via the input/output interface 208. The input device 212 is configured by, for example, a keyboard, a mouse, a multi-touch panel, other pointing devices, a sound input device, or an appropriate combination thereof. The display device 214 is configured by, for example, a liquid crystal display, an organic electro-luminescence (OEL) display, a projector, or an appropriate combination thereof.

In addition, the input device 212 and the display device 214 may be integrated into one unit, such as a touch panel. The input device 212 and the display device 214 may be included in the information processing device 200, or the information processing device 200, the input device 212, and the display device 214 may be configured integrally.

In addition, the processing function of the information processing device 200 is not limited to a case of being implemented by one computer and may be implemented by distributing processing using a plurality of computers.

### <Program Operating Computer>

A program that causes a computer to implement some or all of the processing functions of the information processing device 200 can be recorded on a computer-readable medium such as an optical disk, a magnetic disk, a semiconductor memory, or another tangible non-transitory information storage medium, and the program can be provided through this information storage medium.

In addition, instead of an aspect of providing the program by storing the program in such a non-transitory computer-readable medium, a program signal can also be provided as a download service using a telecommunication line such as the Internet.

Some or all of the processing functions in the information processing device 200 may be implemented by cloud computing, or can be provided as a software as a service (SaaS) offering.

### <Hardware Configuration of Each Processing Unit>

Hardware structures of the processing units that perform various processes, such as the master control unit 150, the conveyance control unit 152, the preliminary drying control unit 154, the printing control unit 156, the main drying control unit 158, the humidification control unit 184, and the exhaust control unit 194 shown in FIGS. 16 to 18 are, for example, various processors shown below.

The various processors include a CPU, which is a general-purpose processor that functions as various processing units by executing programs, a GPU specialized in image processing, a programmable logic device (PLD) of which a circuit configuration can be changed after manufacturing, such as an FPGA, and a dedicated electric circuit, which has a circuit configuration specifically designed to execute particular processing tasks, such as an application specific integrated circuit (ASIC).

A single processing unit may be configured with one of these various processors or two or more processors of the same type or different types. For example, a single processing unit may be configured with a plurality of FPGAs, a combination of a CPU and an FPGA, or a combination of a CPU and a GPU. Additionally, a plurality of processing units may be configured as a single processor. As an example in which a plurality of processing units are configured as a single processor, first, as represented by a computer such as a client or a server, there is a form in which a single processor is configured by a combination of one or more CPUs and software, and this processor functions as a plurality of processing units. Secondly, as represented by a system-on-chip (SoC) or the like, there is a form in which a processor that implements functions of the entire system including a plurality of processing units with a single integrated circuit (IC) chip is used. As described above, the various processing units are configured by using one or more of the various processors as the hardware structure.

Furthermore, the hardware structure of these various processors is, more specifically, an electric circuit (circuitry) in which circuit elements such as semiconductor elements are combined.

### <<Effects of Present Embodiment>>

According to the present embodiment, it is possible to suppress drying failure of the substrate S after image formation and the deformation of the substrate, and it is possible to suppress the jetting failure of the print head 42. As a result, image defects such as streaks are suppressed, and printed matter with good quality can be produced. In addition, in the printing apparatus 10 that performs double-sided printing, a configuration is adopted in which the preliminary drying unit 14 is disposed only before image formation is performed on the front surface, and the absolute humidity in the periphery of the nozzle surface is adjusted only for the print head 42 for the front surface printing, and a similar configuration is not adopted for the back surface printing, so that the cost of unnecessary (excessive) devices can be suppressed.

### Modification Example 1

In the above-described embodiment, the printing apparatus 10 using a page-wide full-line type head has been described. However, an application range of the present disclosure is not limited thereto, and the technology of the present disclosure can also be applied to an ink jet printing apparatus using, for example, a serial-type head in which an image is formed by performing a plurality of passes of head scanning while moving a short-length print head.

### Modification Example 2

Although the printing apparatus 10 that performs double-sided printing of printing an image on both surfaces of the substrate S is illustrated in FIG. 1, a form in which the reversing unit 18 and the back surface printing and main drying unit 20 illustrated in FIG. 1 are not provided, that is, a single-sided printing apparatus that prints an image on one surface of the substrate S may be used.

### Modification Example 3

In the above-described embodiment, an example in which the absolute humidity is adjusted according to the basis weight of the substrate S has been described, but the adjustment is not limited to the basis weight. For example, the absolute humidity may be adjusted according to the attribute of the substrate S to be used by combining other attributes such as the material and/or the size of the substrate S. In addition, a brand may be used as the attribute of the substrate S.

### <<Substrate>>

The substrate S is not particularly limited in material, shape, and the like as long as an image can be formed by applying the aqueous ink, and for example, a permeable medium such as paper, cloth, or wood can be used. The term “substrate” may be understood as a generic term for various terms used in forming an image, such as a recording medium, paper, recording paper, printing paper, a printing medium, a print medium, a printed medium, an image forming medium, an image-formed medium, an image receiving medium, and a jetted medium.

In FIG. 1, an example in which continuous paper is used as the substrate S has been described, but the substrate is not limited to continuous paper and may be a sheet substrate such as cut paper.

### <Conveyance Mechanism of Substrate>

In the above-described embodiment, the printing apparatus 10 of the roll-to-roll method has been described as an example, but the conveyance mechanism that conveys the substrate can adopt various forms such as a drum-based conveying method, a belt-based conveying method, a nip-based conveying method, a chain-based conveying method, and a pallet-based conveying method, and these methods can be combined as appropriate.

### <<Jetting Method of Print Head>>

An ejector of the print head 42 is configured to include a nozzle from which the ink is jetted, a pressure chamber that communicates with the nozzle, and a jetting energy generating element that applies jetting energy to a liquid in the pressure chamber. Regarding a jetting method for jetting liquid droplets from the nozzle of the ejector, a unit for generating the jetting energy is not limited to a piezoelectric element, and various jetting energy generating elements, such as a heat generating element and an electrostatic actuator, can be applied. For example, it is possible to adopt a method of jetting liquid droplets by utilizing a pressure during film boiling due to heating of a liquid by the heat generating element. Depending on the jetting method of the print head 42, a corresponding jetting energy generating element is provided in a flow passage structure.

### <<Terms>>

The term “printing apparatus” includes the concepts of terms such as a printing machine, a printing system, an image forming device, a printer, a printing apparatus, an image recording device, an image output device, and a drawing device.

The term “printing” includes the concepts of terms such as forming of an image, recording of an image, printing, drawing, and print.

The term “image” is to be construed in a broad sense, and includes a color image, a black-and-white image, a monochromatic image, a gradation image, a uniform density (solid) image, and the like. The term “image” is not limited to a photographic image, and is used as a comprehensive term including a pattern, text, symbols, line drawings, a mosaic pattern, a color fill pattern, various other patterns, or an appropriate combination thereof.

### Combination of Embodiments and Modification Examples

The configurations described in the above-described embodiments and the features described in the modification examples may be used in appropriate combinations, and some features may be substituted.

### <<Others>>

The present disclosure is not limited to the embodiments described above, and various modifications can be made without departing from the gist of the technical idea of the present disclosure.

### EXPLANATION OF REFERENCES

10: printing apparatus
12: paper feed unit
14: preliminary drying unit
16: front surface printing and main drying unit
18: reversing unit
20: back surface printing and main drying unit
22: paper discharge unit
30: heating device
32: hot air unit
34: heat roller
36: pass roller
38: cooling roller
40: pass roller
42: print head
42K, 42C, 42M, 42Y: print head
43: head box
43A: wall frame
44: radiation heating unit
46: drying cylinder
48: first-touch roller
50: tube
52: support member
54: humidifier
60: humidifier
62: support member
64: tank
65: nozzle
70: duct
80, 82, 84: intake flow passage
90, 92, 94: exhaust flow passage
150: master control unit
150A: processor
150B: memory
152: conveyance control unit
154: preliminary drying control unit
156: printing control unit
158: main drying control unit
160: sensor
170: conveyance mechanism
180: humidifier
184: humidification control unit
190: blower
194: exhaust control unit
200: information processing device
202: processor
204: computer-readable medium
206: communication interface
208: input/output interface
210: bus
212: input device
214: display device
216: memory
218: storage
252: conveyance control program
254: preliminary drying control program
256: printing control program
258 main drying control program
260: humidification control program
262 exhaust control program
270: preliminary drying path table
272: preliminary drying condition table
274: humidification amount adjustment table
276: exhaust amount adjustment table
FIG. 13A: left diagram
FIG. 13B: right diagram
S: substrate

What is claimed is:

1. A drying device that reduces moisture in a substrate before jetting aqueous ink to form an image, the drying device comprising:
pass rollers configured to convey the substrate;
heat rollers disposed on a conveyance path of the substrate conveyed by the pass rollers; and
hot air units disposed between the heat rollers,
wherein the conveyance path comprises conveyance path segments arranged in a multilayer structure.

2. The drying device according to claim 1,
wherein the heat rollers and the hot air units are disposed on each of the conveyance path segments at different heights.

3. The drying device according to claim 1,
wherein the conveyance path segments are alternately arranged in a height direction.

4. The drying device according to claim 1,
wherein the heat rollers and the hot air units are respectively configured to adjust their temperature settings according to an attribute of the substrate.

5. The drying device according to claim 1,
wherein a conveyance speed of the substrate is adjustable according to an attribute of the substrate.

6. The drying device according to claim 1,
wherein the number of the heat rollers and the hot air units is changeable according to an attribute of the substrate.

7. The drying device according to claim 1,
wherein the heat rollers and the hot air units heat the substrate to bring the substrate into a falling-rate drying state.

8. The drying device according to claim 1, further comprising
a roller configured to adjust a temperature of the substrate downstream of the heat rollers.

9. The drying device according to claim 1, further comprising
an absolute humidity adjustment unit configured to adjust an absolute humidity in a periphery of a nozzle surface of a print head that jets an aqueous ink onto the substrate to form an image.

10. The drying device according to claim 9,
wherein the absolute humidity adjustment unit comprises:
an exhaust unit configured to exhaust dry air from an inside of a printing apparatus; and
an intake unit configured to take in humid outside air to the inside of the printing apparatus, and
the absolute humidity adjustment unit adjusts an exhaust amount by the exhaust unit to adjust the absolute humidity in the periphery of the nozzle surface.

11. The drying device according to claim 4,
wherein the attribute of the substrate includes a basis weight of the substrate.

12. The drying device according to claim 10,
wherein the absolute humidity adjustment unit includes a processor configured to adjust the exhaust amount according to an attribute of the substrate.

13. A drying device that reduces moisture in a substrate before ejecting aqueous ink to form an image, the drying device comprising:
pass rollers configured to convey the substrate;
heat rollers disposed on a conveyance path of the substrate conveyed by the pass rollers; and
hot air units disposed between the heat rollers,
wherein the conveyance path comprises conveyance path segments alternately arranged in a height direction,
the heat rollers and the hot air units are disposed on each of the conveyance path segments, and
at least one of the temperature settings of the heat rollers and the hot air units is adjustable according to an attribute of the substrate, and/or a conveyance speed of the substrate is adjustable according to the attribute of the substrate.

14. A printing apparatus comprising:
the drying device according to claim 1; and
a print head configured to jet an aqueous ink onto a substrate to form an image.

15. The printing apparatus according to claim 14, comprising
a second drying device configured to dry the substrate onto which the aqueous ink has been jetted by the print head.

16. The printing apparatus according to claim 14, comprising
an electrostatic elimination device disposed between the drying device and the print head, and configured to remove static electricity from the substrate.

17. The printing apparatus according to claim 14, comprising
a second print head configured to, after the image has been formed on a first surface of the substrate by the print head as a first print head, form an image on a second surface being opposite to the first surface of the substrate,
wherein out of upstream sides of image formation on the first surface and image formation on the second surface, the drying device is provided only upstream of image formation on the first surface.

18. A printing apparatus comprising:
the drying device according to claim 13; and
a print head configured to jet an aqueous ink onto a substrate to form an image.

19. The printing apparatus according to claim 18, comprising
a second drying device configured to dry the substrate onto which the aqueous ink has been jetted by the print head.

20. The printing apparatus according to claim 18, comprising
an electrostatic elimination device disposed between the drying device and the print head, and configured to remove static electricity from the substrate.
